(19) United States
(12) Patent Application Publication
(10) Pub. No.: US 2012/0251701 A1
(43) Pub. Date: Oct. 4, 2012

(54) METHOD FOR PRODUCING HOLLOW NOODLES

(75) Inventors: Soo Hyun Park, Seongnam-si (KR); Jong Jin Lee, Anyang-si (KR); Nam Jae Kang, Suwon-si (KR); Kyung Bae Kim, Anyang-si (KR); Tae Kwon Bang, Gangnam-gu (KR); Jun Ho Hwang, Jungnang-gu (KR)

(73) Assignee: NONG SHIM CO., LTD., Seoul (KR)

(21) Appl. No.: 13/516,207

(22) PCT Filed: Dec. 18, 2009
(86) PCT No.: PCT/KR2009/007595

§ 371 Date: Jun. 14, 2012

(30) Foreign Application Priority Data
Dec. 16, 2009 (KR) 10-2209-0125586

(51) Int. Cl. A23L 1/16; A23L 3/40; A23P 1/10

(52) U.S. Cl. 426/557; 426/451

(57) ABSTRACT

The present invention relates to a method for producing hollow noodles, and more specifically to one in which a gelatinized doughy substance is passed through a die designed to form a hollow area, such that the noodles which have passed therethrough have a tubular hollow area on the inside and hence it is possible to produce noodles which have a dramatically reduced cooking time and readily allow soap and sauces to penetrate the noodle during cooking and so enhance the taste thereof. Further, it is possible to produce noodles in which the formation of the hollow causes the noodle surface area to be increased and, as a result, there is rapid evaporation of the water present on the surface of the noodle which is being gelatinized and injected, and hence noodle stickiness is dramatically improved and consequently noodle sticking is reduced.

### TECHNICAL FIELD

The present invention relates to a method for producing hollow noodles. More specifically, the present invention relates to a method for producing hollow noodles in which a gelatinized doughy substance is passed through a die designed to form a hollow area, such that the noodles which have passed therethrough have a tubular hollow area on the inside, to obtain noodles which have a dramatically reduced cooking time and readily allow soap and sauces to penetrate the noodles during cooking and thereby enhance the taste thereof.

In addition, the present invention relates to hollow noodles in which the formation of the hollow causes the noodle surface area to be increased and, as a result, there is rapid evaporation of the water present on the surface of the noodle which is being gelatinized and injected, and hence noodle stickiness is dramatically improved and consequently noodle sticking is reduced.

### BACKGROUND ART

Noodles are world's favorite foods. Noodle food cultures are developed in the eastern nations including three nations of Korea, China and Japan, as well as, Vietnam, Thailand and Indonesia, and the western nations in which pasta is used for two meals among three meals a day.

The cooking time of noodles greatly depends on processing method thereof. Depending on processing method, noodles are generally classified into fried noodles and dried noodles. Fried noodles are obtained by frying steamed noodles in a high-temperature oil. During frying, many pores are formed in noodle strands due to a puffing phenomenon. Dried noodles are obtained by drying noodle strands that are steamed or noodle strands passing through a high-temperature injection machine, which are denser than porous fried noodles. Accordingly, at a constant noodle strand thickness, dried noodles require a longer cooking time than fried noodles.

Of commercially available dried noodles, most of noodles having thick noodle strands are pasta. For example, it takes 3 minutes to cook pastas having a thickness of 1.65 mm (practically measured outer diameter) and it takes 11 minutes to cook pastas having a thickness of 1.85 mm.

As a result of consumer survey, it can be seen that consumers want cook noodles having a cooking time of 5 minutes or less. However, some voluminous traditional pasta products should be cooked for 10 to 12 minutes.

Clearly, consumers desire a shorter cooking time of noodles.

In order to reduce cooking time, the time in which moisture is permeated into the center of noodle strands may be reduced by making noodle strands thin. In this case, excessively thin noodle strands reduce noodle volume, thus resulting in deterioration in taste. Alternatively, a puffing level of fried noodles is increased during processing. In this case, the subsequent taste of noodles is excessively rapidly reduced.

As a method for reducing a restoration time, while maintaining the volume of noodle strands, there is formation of tubes in noodle strands.

As a patent associated with production of hollow noodles, Korean Patent No. 0264612, entitled “apparatus for producing noodles having a hollow and the hollow noodles” discloses a method for producing hollow noodles by forming two noodle tools, overlapping the tools and passing the same through a slitter. This method requires equipment for forming two noodle tools and is limited to slit noodles.

### DISCLOSURE

### Technical Problem

Therefore, the present invention has been made in an attempt to greatly reduce noodle cooking time, and it is one object of the present invention to provide hollow noodles, in which grains such as wheat powder, rice powder and starch are gelatinized and the gelatinized substance is passed through a die designed to form a hollow area, such that the noodles which have passed therethrough have a hollow area on the inside, to obtain noodles which have a dramatically reduced cooking time and readily allow soap and sauces to penetrate the noodles during cooking and thereby enhance the taste thereof.

Also, it is another object of the present invention to provide hollow noodles in which the formation of the hollow causes the noodle surface area to be increased and, as a result, there is rapid evaporation of the water present on the surface of the noodle which is being gelatinized and injected, and hence noodle stickiness is dramatically improved and consequently noodle sticking is reduced.

### Technical Solution

In accordance with one aspect of the present invention, provided is a method for producing hollow noodles including: kneading and gelatinizing 100 parts by weight of a noodle raw material and 33 to 37 parts by weight of a mixing water in a first injection machine; passing the gelatinized doughy substance through a second injection machine to form hollow noodles; preliminary-drying the formed hollow noodles at 65 to 75° C. and at a relative humidity of 20% for 3 to 5 minutes; and main-drying the preliminary-dried noodles at 45 to 60° C. and at a relative humidity 40% for 60 minutes.

The noodle raw material may be at least one selected from the group consisting of rice powder, wheat powder, barley powder, buckwheat powder, corn powder, sorghum powder, Italian millet powder, oat powder, mung bean powder, millet powder, bean powder, barnyard millet powder and starch.

The noodle raw material may contain 70 to 90 parts by weight of rice powder, 5 to 20 parts by weight of potato starch, 5 to 25 parts by weight of buckwheat powder, barley powder or corn powder, and 0.2 to 3 parts by weight of cellulose powder.

The mixing water may contain 0.5 to 5 parts by weight of refined salt, 0.5 to 2 parts by weight of kelp extract, 0.5 to 5 parts by weight of a flavor enhancing liquid and distilled water, with respect to 100 parts by weight of the noodle raw material.

The first injection machine may be set to a temperature of 100 to 120° C.

The gelatinized doughy substance may have a water content of 27 to 33%.

The gelatinized doughy substance may have a gelatinization degree of 70 to 95%.

The second injection machine may be set to a temperature of 30 to 50° C.

The thickness of the hollow noodles may be formed by combination of an outer diameter and an inner diameter, and may be 0.2 mm to 1.0 mm.

The outer diameter of the hollow noodles may be 1.5 to 2.5 mm.

### Advantageous Effects

As apparent from the fore-going, hollow noodles according to the present invention can greatly reduce cooking time of noodles using grains, exhibit rapid moisture evaporation and thus excellent processability due to increased noodle surface area, although a considerably sticky noodle raw material is used, and allow soap and sauces to be readily permeated into noodle strands during cooking and exhibit improved taste.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a method for producing hollow noodles; and

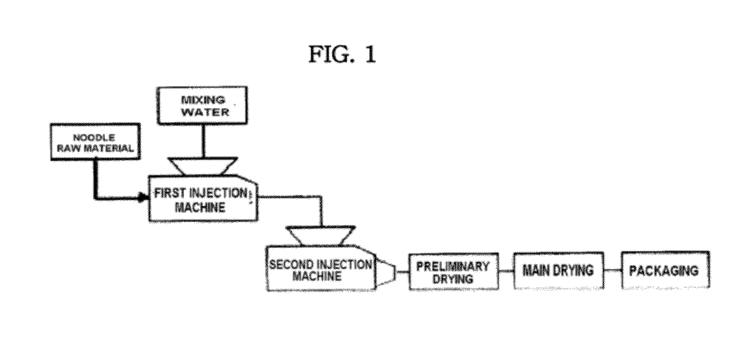

FIG. 2 illustrates a principle in which the thickness of noodle strands of hollow noodles is determined.

### BEST MODE

Hereinafter, the present invention will be described in detail.

According to the method for producing hollow noodles of the present invention, a gelatinized doughy substance is passed through a die for forming hollows to produce noodles having hollows in noodle strands.

When the gelatinized doughy substance passes through the die, it is molded into noodle strands having an outer diameter and an inner diameter.

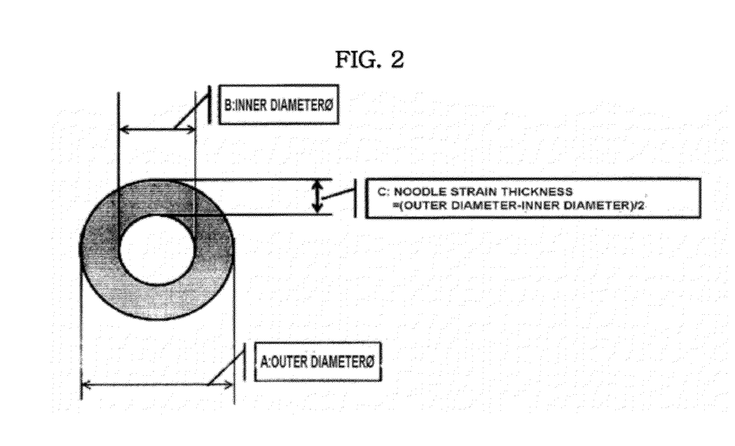

At this time, as shown in FIG. 2, the thickness of noodle strands is half the difference between the outer diameter and the inner diameter. When noodles are cooked, a user feels the volume of noodle strands due to the outer diameter. As the thickness of noodle strands decreases, cooking time decreases. As a result, noodles capable of satisfying consumers' requirements of cooking and eating thick noodles as quick as possible can be produced.

### PREPARATIVE EXAMPLE

Mixing Noodle Raw Material

Examples of the noodle raw material include rice powder, wheat powder, barley powder, buckwheat powder, corn powder, sorghum powder, Italian millet powder, oat powder, mung bean powder, millet powder, bean powder, barnyard millet powder, starch and the like.

When rice powder is used as the noodle raw material, the rice powder may be used singly or a mixture of 70 to 90 parts by weight of rice powder, 5 to 20 parts by weight of potato starch, and 5 to 25 parts by weight of buckwheat powder, barley powder or corn powder, and 0.2 to 3 parts by weight of cellulose powder may be used.

Kneading and Gelatinizing

A mixing water is added to a kneader containing noodle raw materials and the kneader is heated to 100 to 120° C. to gelatinize a dough. Generally, kneading and gelatinizing are completed within a short time of 20 to 40 seconds. Gelatinization is carried out such that the gelatinization degree becomes 70 to 95%.

Alternatively, gelatinization is carried out at 120° C. so that the dough can be optimally gelatinized.

The mixing water used for kneading is obtained by mixing 0.5 to 5 parts by weight of refined salt, 0.5 to 2 parts by weight of a kelp extract, 0.5 to 5 parts by weight of a flavor enhancing liquid and the balance of distilled water, with respect to 100 parts by weight of the noodle raw material.

The kelp extract is particularly advantageous when a noodle raw material such as rice powder that frequently undergoes starch elusion is used. When the amount of kelp extract added is 0.4 parts by weight with respect to 100 parts by weight of the noodle raw material, starch elution control effects of noodles is insufficient, and when the amount is higher than 2.1 parts by weight or more, hollow noodles feel hard in texture and have a smooth surface, thus causing deterioration in taste and flavor.

The mixing water is present in an amount of 33 to 37 parts by weight, with respect to 100 parts by weight of the noodle raw material. When the mixing water is present at 38 parts by weight or more, with respect to 100 parts by weight of the noodle raw material, it is difficult to transfer a dough lump into an injection machine, and when the amount is 32 parts by weight or less, hollow noodles are excessively swollen and starch elution thus becomes serious.

A gelatinized state of the dough containing the noodle raw material and the mixing water is different from a general gelatinized state of rice cake (Korean traditional food, called “Tteok”) or the like. The gelatinized dough of the present invention has a water content of 27 to 33% and exhibits superior transfer and processing properties. On the other hand, generally, the gelatinized state of a substance such as rice cake has a high water content of 45 to 55%, thus lacking transfer and processing properties of hollow dry noodles. In addition, gelatinization of the present invention is performed while kneading. The dough containing the noodle raw material and the mixing water according to the present invention is gelatinized only by heating in a first injection machine at 100 to 120° C. for 20 to 40 seconds, while the gelatinized state such as rice cake is gelatinized while steaming for 20 minutes or longer. That is, the dough of the present invention is different from the general gelatinized substance in terms of gelatinization method.

Kneading is carried out such that the gelatinization degree is adjusted to 70 to 95% to prevent gelatinized noodle stripes from sticking to one another.

Forming noodle strands using second injection machine

The transferred mass of dough is injected into a second injection machine in which the temperature is set at 30 to 50° C. to form hollow noodle strands in which the size thereof is determined by a combination of a hollow noodle outer diameter and a hollow noodle inner diameter.

Any injection die used for formation of hollows in noodle strands in the second injection machine may be selected from general injection dies to form hollow noodles, so long as it is capable of producing noodle strands having a hollow noodle outer diameter of 1.5 to 2.5 mm and a hollow noodle thickness of 0.2 to 1.0 mm, as described below.

More specifically, in the process of setting the thickness of noodle strands via a combination of an outer diameter and an inner diameter and the injecting noodle strands, the injected noodle strands are cut to a thickness of 0.2 mm to 1.0 mm.

The thickness of noodle strands is determined using a combination of an outer diameter within a range of 1.5 mm to 2.5 mm with an inner diameter (See FIG. 2).

When the thickness of noodles is smaller than 0.2 mm, hollow noodles have a low shape retaining property and are thus deformed, and when the thickness is higher than 1.0 mm, cooking time exceeds 8 minutes and texture is disadvantageously hard due to the large thickness.

In the aforementioned method, the molding process may be carried out under common molding conditions.

Since the formation of hollow noodles using the second injection machine is accomplished within a short period of time, although the temperature of the second injection machine is set to 30 to 50° C., the temperature of dough mass gelatinized at a high temperature of 100 to 120° C. and the temperature of hollow noodles formed via the second injection machine are not cooled to the set temperature of the second injection machine. Accordingly, the hollow noodles injected from the second injection machine that is still present under the high temperature have an increased surface area and the amount of moisture escaping from the hollow noodles is great. For this reason, unlike general noodles (non-hollow noodles), hollow noodle strands do not require surface drying to prevent noodle sticking before preliminary drying.

Preliminary Drying

Preliminary drying is carried out at a temperature of to 75° C. and at a relative humidity of 20% for 3 to 5 minutes to control an air spray pressure and thereby to prevent agglomeration of molded noodles in order to homogeneously disperse the cut hollow noodles and form as many pores as possible therein.

Regarding the preliminary drying conditions, when the temperature is lower than 65° C., drying is not accomplished and noodles are agglomerated during storage and when the temperature is higher than 75° C., noodle strands are cracked and noodle strands are thus broken.

Main Drying

The main drying is carried out by drying at a temperature of 53° C. and a relative humidity of 40% for 60 minutes and cooling to room temperature using cool air.

Regarding the drying conditions, when the temperature is lower than 45° C., drying is not accomplished and, during storage, hollow noodles go moldy, and when the temperature exceeds 60° C., hollow noodles turn in color, that is, are disadvantageously browned.

Drying is performed via two steps including low-temperature drying and high-temperature drying in a controlled relative humidity state. When drying is excessively fast, the surface contacting air is primarily dried, drying of inner structure of noodle strands is delayed, the shape is bent, noodle strands are broken during drying due to distortion of inner stress, and noodle strands are cracked after drying. This two-step drying aims to control drying speed in order to prevent these phenomena.

When the surface of noodle strands is dried, the difference in moisture between the surface and the inside occurs and moisture present inside moves to the surface. When the movement of moisture present inside is delayed, as compared to the movement of moisture on the surface, the aforementioned bad phenomena occur. Accordingly, it is important to reduce evaporation of moisture on the surface and thus to induce diffusion of moisture from the inside to the surface.

Accordingly, when drying is performed at a relatively high temperature and at a predetermined humidity, as described above, inside moisture is primarily moved to the surface and the shape of noodles can be maintained while pores of noodle strands are maximized.

In addition, secondary drying is performed at a reduced temperature and at an increased humidity, to minimize a drying speed of the noodle surface and maintain inner moisture diffusion and speed, and thereby to produce dense and transparent injected and dried noodles.

### Mode for Invention

Hereinafter, preferred embodiments of the present invention will be described in detail. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method the inventor knows for carrying out the invention.

Therefore, the configurations described in the embodiments and drawings of the present invention are merely most preferable embodiments but do not represent all of the technical spirit of the present invention. Thus, the present invention should be construed as including all the modifications, equivalents, and substitutions included in the spirit and scope of the present invention at the time of filing this application.

### Example 1

100 parts by weight of rice powder as a noodle raw material was charged into a kneader, and 35 parts by weight of a mixing water was added thereto with respect to 100 parts by weight of rice powder. The mixing water consists of 3 parts by weight of refined salt, 1.2 parts by weight of a kelp extract, 3 parts by weight of a flavor enhancing liquid and water, with respect to 100 parts by weight of the noodle raw material. The noodle raw material and the mixing water were added to the kneader, the resulting mixture was kneaded and gelatinized at 110° C., and the gelatinized dough mass was cut at a predetermined weight and transferred to an air shift. The hollow noodles were injected to a thickness of 0.5 mm via combination of an outer diameter of φ2.0 mm and an inner diameter of φ1.0 mm in the injection machine. Cutting was performed while inhibiting sticking of injected noodles. Preliminary drying was performed at a temperature of 70° C. and a relative humidity of 20% for 3 to 5 minutes at a controlled air spray pressure in order to prevent agglomeration of molded noodles so that the cut hollow noodles could be homogeneously dispersed and pores thereof could be produced as much as possible. Drying was carried out at a temperature of 53° C. and a relative humidity of 40% for 60 minutes, and cooled to room temperature using cold air to produce hollow noodles.

### Example 2

Hollow noodles were produced in the same manner as in Example 1 except that the kelp extract was added in an amount of 1.0 part by weight, with respect to 100 parts by weight of the rice powder.

### Example 3

Hollow noodles were produced in the same manner as in Example 1 except that the kelp extract was added in an amount of 1.5 parts by weight, with respect to 100 parts by weight of the rice powder.

### Example 4

Hollow noodles were produced in the same manner as in Example 1 except that the mixing water was added in an amount of 34 parts by weight, with respect to 100 parts by weight of the rice powder.

### Example 5

Hollow noodles were produced in the same manner as in Example 1 except that the mixing water was added in an amount of 36 parts by weight, with respect to 100 parts by weight of the rice powder.

### Example 6

Hollow noodles were produced in the same manner as in Example 1 except that the hollow noodles were injected to a thickness of 0.4 mm via combination of an outer diameter of φ2.0 mm, an inner diameter of φ1.2 mm.

### Example 7

Hollow noodles were produced in the same manner as in Example 1 except that the hollow noodles were injected to a thickness of 0.7 mm via combination of an outer diameter of φ2.5 mm and an inner diameter of φ1.1 mm.

### Example 8

Hollow noodles were produced in the same manner as in Example 1 except that the hollow noodles were preliminarily dried at a temperature of 67° C. and a relative humidity of 20% for 3 to 5 minutes.

### Example 9

Hollow noodles were produced in the same manner as in Example 1 except that the hollow noodles were preliminarily dried at a temperature of 73° C. and a relative humidity of 20% for 3 to 5 minutes.

### Example 10

Hollow noodles were produced in the same manner as in Example 1 except that the hollow noodles were main-dried at a temperature of 48° C. and a relative humidity of 40% for 60 minutes and cooled to room temperature using a cold air.

### Example 11

Hollow noodles were produced in the same manner as in Example 1 except that the hollow noodles were main-dried at a temperature of 57° C. and a relative humidity of 40% for 60 minutes and cooled to room temperature using cold air.

### Comparative Example 1

Hollow noodles were produced in the same manner as in Example 1 except that kelp extract was not used.

### Comparative Example 2

Hollow noodles were produced in the same manner as in Example 1 except that the kelp extract was added in an amount of 0.4 parts by weight, with respect to 100 parts by weight of the rice powder.

### Comparative Example 3

Hollow noodles were produced in the same manner as in Example 1 except that the kelp extract was added in an amount of 2.1 parts by weight, with respect to 100 parts by weight of the rice powder.

### Comparative Example 4

Hollow noodles were produced in the same manner as in Example 1 except that the mixing water was added in an amount of 32 parts by weight, with respect to 100 parts by weight of the rice powder.

### Comparative Example 5

Hollow noodles were produced in the same manner as in Example 1 except that the mixing water was added in an amount of 38 parts by weight, with respect to 100 parts by weight of the rice powder.

### Comparative Example 6

Hollow noodles were produced in the same manner as in Example 1 except that the hollow noodles were injected to a thickness of 0.1 mm via combination of an outer diameter of φ2.0 mm and an inner diameter of φ1.8 mm.

### Comparative Example 7

Hollow noodles were produced in the same manner as in Example 1 except that the hollow noodles were injected to a thickness of 1.1 mm via combination of an outer diameter of φ2.7 mm and an inner diameter of φ0.5 mm.

### Comparative Example 8

Hollow noodles were produced in the same manner as in Example 1 except that the hollow noodles were preliminarily dried at a temperature of 64° C. and a relative humidity of 20% for 3 to 5 minutes.

### Comparative Example 9

Hollow noodles were produced in the same manner as in Example 1 except that the hollow noodles were preliminarily dried at a temperature of 76° C. and a relative humidity of 20% for 3 to 5 minutes.

### Comparative Example 10

Hollow noodles were produced in the same manner as in Example 1 except that the hollow noodles were main-dried at a temperature of 44° C. and a relative humidity of 40% for 60 minutes and cooled to room temperature using a cold air.

### Comparative Example 11

Hollow noodles were produced in the same manner as in Example 1 except that the hollow noodles were main-dried at a temperature of 61° C. and a relative humidity of 40% for 60 minutes and cooled to room temperature using cold air.

### EXPERIMENTAL EXAMPLE

32 sensory evaluation experts conducted evaluation regarding taste, noodle texture, noodle sogginess and elution degree of hollow noodles of Examples 1 to 10 and Comparative Examples 1 to 11.

Results are shown in Table 1 below.

TABLE 1

| | | | Noodle | | | |
|---|---|---|---|---|---|---|
| | | | soggi- | Starch | | |
| | Taste | Texture | ness | elution | Cooking time | |
| Ex. 1 | Excellent | Good | Good | Low | 4 | min 30 sec |
| Ex. 2 | Excellent | Good | Good | Low | 4 | min 30 sec |
| Ex. 3 | Excellent | Good | Good | Low | 4 | min 30 sec |
| Ex. 4 | Excellent | Good | Good | Low | 4 | min 30 sec |
| Ex. 5 | Excellent | Good | Good | Low | 4 | min 30 sec |
| Ex. 6 | Excellent | Good | Good | Low | 4 | min |
| Ex. 7 | Excellent | Good | Good | Low | 6 | min |
| Ex. 8 | Excellent | Good | Good | Low | 4 | min 30 sec |
| Ex. 9 | Excellent | Good | Good | Low | 4 | min 30 sec |
| Ex. 10 | Excellent | Good | Good | Low | 4 | min 30 sec |
| Ex. 11 | Excellent | Good | Good | Low | 4 | min 30 sec |
| Comp. Ex. 1 | Not clean | Bad | Readily | High | 4 | min 30 sec |
| | | | soggy | | | |
| Comp. Ex. 2 | Not clean | Bad | Readily | High | 4 | min 30 sec |
| | | | soggy | | | |
| Comp. Ex. 3 | Excellent | Hard | Good | Low | 4 | min 30 sec |
| Comp. Ex. 4 | Not clean | Bad | Readily | High | 4 | min 30 sec |
| | | | soggy | | | |
| Comp. Ex. 5 | Not clean | Bad | Readily | Very high | 4 | min 30 sec |
| | | | soggy | | | |
| Comp. Ex. 6 | Not clean | Bad | Readily | High | 3 | min |
| | | | soggy | | | |
| Comp. Ex. 7 | Excellent | Hard | Good | Low | 10 | min |
| Comp. Ex. 8 | Not clean | Very | Readily | Very high | 4 | min 30 sec |
| | | bad | soggy | | | |
| Comp. Ex. 9 | Burn taste | Hard | Good | Medium | 4 | min 30 sec |
| Comp. | Bad | Bad | Readily | Very high | 4 | min 30 sec |
| Ex. 10 | | | soggy | | | |
| Comp. | Burn taste | Hard | Good | Medium | 4 | min 30 sec |
| Ex. 11 | | | | | | |

As can be seen from Table 1 above, when, in the production of hollow noodles according to the present invention, the thickness of noodle strands determined via combination of outer diameter and inner diameter is lower than 0.2 mm (Comparative Example 6), the texture of noodles was bad and noodles readily became soggy after cooking, and when the thickness exceeds 1.0 mm (Comparative Example 7), the texture of hollow noodles was hard and cooking time reached 10 minutes, thus entailing a long period of time.

The mixing water is added in an amount of 35 parts by weight, with respect to 100 parts by weight of the rice powder. When the content is lower than 33 parts by weight (Comparative Example 4), hollow noodles and noodles were excessively swollen and thus excessively elute starch, and when the content exceeds 37 parts by weight (Comparative Example 5), disadvantageously, a mass of dough is not readily transferred in an injection machine.

When the noodle strands produced using the outer diameter/inner diameter combination of hollow noodles have a thickness lower than 0.2 mm (Comparative Example 6), the noodle strands of hollow noodles are thin and are thus readily gelatinized, causing serious starch elution and deterioration in noodle taste, and when the thickness exceeds 1.0 mm (Comparative Example 7), hollow noodles disadvantageously have a long cooking time and hard texture.

Regarding preliminary drying conditions, when the temperature is lower than 65° C. (Comparative Example 8), drying is not accomplished and hollow noodles are agglomerated during storage and when the temperature exceeds 75° C. (Comparative Example 9), carbide of hollow noodles is disadvantageously produced.

Regarding drying conditions, when the temperature is lower than 45° C. (Comparative Example 10), drying is not accomplished and storage problems occur, for example, hollow noodles go moldy during storage, and when the temperature exceeds 60° C. (Comparative Example 11), hollow noodles turn in color, that is, are disadvantageously browned.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for producing hollow noodles comprising:
kneading and gelatinizing 100 parts by weight of a noodle raw material and 33 to 37 parts by weight of a mixing water in a first injection machine;
passing the gelatinized doughy substance through a second injection machine to form hollow noodles;
preliminary-drying the formed hollow noodles at 65 to 75° C. and at a relative humidity of 20% for 3 to 5 minutes; and
main-drying the preliminary-dried noodles at 45 to 60° C. and at a relative humidity 40% for 60 minutes.

2. The method according to claim 1, wherein the noodle raw material is at least one selected from the group consisting of rice powder, wheat powder, barley powder, buckwheat powder, corn powder, sorghum powder, Italian millet powder, oat powder, mung bean powder, millet powder, bean powder, barnyard millet powder and starch.

3. The method according to claim 2, wherein the noodle raw material comprises 70 to 90 parts by weight of rice powder, 5 to 20 parts by weight of potato starch, 5 to 25 parts by weight of buckwheat powder, barley powder or corn powder, and 0.2 to 3 parts by weight of cellulose powder.

4. The method according to claim 1, wherein the mixing water comprises 0.5 to 5 parts by weight of refined salt, 0.5 to 2 parts by weight of kelp extract, 0.5 to 5 parts by weight of a flavor enhancing liquid and distilled water, with respect to 100 parts by weight of the noodle raw material.

5. The method according to claim 1, wherein the first injection machine is set to a temperature of 100 to 120° C.

6. The method according to claim 1, wherein the gelatinized doughy substance has a water content of 27 to 33%.

7. The method according to claim 1, wherein the gelatinized doughy substance has a gelatinization degree of 70 to 95%.

8. The method according to claim 1, wherein the second injection machine is set to a temperature of 30 to 50° C.

9. The method according to claim 1, wherein the thickness of the hollow noodles is formed by combination of an outer diameter and an inner diameter, and is 0.2 mm to 1.0 mm.

10. The method according to claim 9, wherein the outer diameter of the hollow noodles is 1.5 to 2.5 mm.
